(19) United States
(12) Patent Application Publication
(10) Pub. No.: US 2011/0311806 A1
(43) Pub. Date: Dec. 22, 2011

(54) METHOD FOR MANUFACTURING PANELS AND PANELS OBTAINED HEREBY

(76) Inventors: Laurent Meersseman, Kortrijk (BE); Luc Vanhastel, Tielt (BE)

(21) Appl. No.: 13/201,133

(22) PCT Filed: Feb. 26, 2010
(86) PCT No.: PCT/IB2010/050849

§ 371 Date: Aug. 11, 2011

(30) Foreign Application Priority Data
Mar. 12, 2009 (BE) BE2009/0146

(51) Int. Cl. B32B 3/00; B29C 43/20

(52) U.S. Cl. 428/332; 264/78

(57) ABSTRACT

A method for manufacturing panels including a substrate on the basis of a pressed material mass, whereby it is started from a material mass to be densified, wherein the density of this material mass, in one or more densifying steps, is at least doubled. Prior to one or more of these densifying steps, a colorant is added to the material mass.

### BACKGROUND OF THE INVENTION

1. Field of the Invention

This invention relates to a method for manufacturing panels and to panels obtained hereby.

More particularly, the invention relates to panels comprising a substrate, wherein this substrate substantially consists of a pressed material mass.

2. Related Art

Such panels are known as such. The substrates applied herein may consist, for example, of wood particle board or wood fiberboard, such as MDF or HDF (Medium Density Fiberboard or High Density Fiberboard). According to the state of the art, such panels, at least at one flat side thereof, can be finished with a top layer forming a separate decor. For example, from WO 97/47834 laminate floor panels are known, wherein MDF or HDF (Medium Density Fiberboard or High Density Fiberboard) is applied for the substrate and wherein one or more paper layers provided on this substrate are applied for the top layer. One of said paper layers then is provided with a print, for example, with a wood motif. Traditionally, such MDF or HDF board consists of pressed wood fibers, which are connected, for example, by means of melamine formaldehyde glue (MF) or melamine urea formaldehyde glue (MUF). It is also known to apply colored substrates for such laminate floor panel, for example, for indicating that a board with better waterproof or fire-retarding features is concerned. However, the disadvantage of a laminate floor panel is that with wear traces of minor depth, the decor-forming top layer already is damaged such that it is no longer esthetically attractive.

From WO 2005/054600, it is also known to provide the entire material mass of a floor panel with color pigments, wherein the obtained coloration forms the decor of the floor panel. The floor panels known from these patent applications are manufactured by consolidating said material mass in a closed mold, wherein then also a certain structure may be obtained at the surface of the floor panel. Such floor panel and production procedure are expensive. Moreover, in such floor panels no patterns or motifs can be formed by means of the color pigments, or anyway the possibilities therefor certainly are limited.

From EP 1 624 975, it is known to color wood by means of staining, wherein by coloring, the pattern or motif of inlaid wood is obtained. Herein, this may relate to staining wood fiberboard or wood particle board. Generally, it is known that staining agents can penetrate into the substrate over a very limited depth only and that it is difficult to obtain a good color rendition at the surface of the substrate. Moreover, it is possible that staining a wood fiberboard or wood particle board softens the surface of these boards, as a result of which, for example, the resistance against impact load at this surface may be reduced, even when this surface should be protected by means of a synthetic material layer.

### SUMMARY

The present invention aims at an alternative method for manufacturing panels with a colored side, wherein according to various preferred embodiments a more economical and/or efficient technique is offered, which also can offer new possibilities and/or solutions for the problems with the techniques from the state of the art. To this aim, the invention, according to its first aspect, relates to a method for manufacturing panels comprising a substrate on the basis of a pressed material mass, whereby it is started from a material mass to be densified, wherein the density of this material mass, in one or more densifying steps, is at least doubled, with the characteristic that prior to one or more of these densifying steps, a colorant is added to the material mass. It is clear that the colorant is added to a material mass which already has been at least partially composed. Preferably, said densifying steps are performed on one and the same line. Preferably, also composing the material mass is performed in the same line. Preferably, the respective substrate achieves its final density also on the same line. Preferably, all steps between composing the material mass and achieving the final density of the substrate are performed in a continuous manner, i.e., as a continuous flow process.

It is noted that such densifying step may comprise a press treatment and/or a heating operation. Preferably, said colorant is added prior to one or more press treatments and/or in between two press treatments. Preferably, the material mass, when said colorant is added, is in a state in which it has less than half of its final density and still better has less than a fourth of its final density. Thus, preferably the density of the material mass still is at least doubled after adding the colorant. Due to the fact that an essential part of the densification then takes place after the addition of the colorant, it is obtained that the colorant, on the one hand, can penetrate well into the material mass and in this manner can reach a large part of the material mass, whereas, on the other hand, this colored part of the material mass, together with the remaining part of the material mass, still can be strongly densified in order to obtain acceptable surface properties, such as an acceptable resistance against impact load, for example, for floor or furniture applications. By afterwards densifying the colored material mass, the provided colorants are concentrated on the surface of the panel, such that a good color rendition can be obtained. It is not excluded that the material mass, when adding said colorant, is in a condition in which it shows a density of at least 90% of its final density. By means of such embodiment, it is possible to obtain colorations with patterns or motifs of a higher resolution, for example, with a resolution of more than 50 dpi.

Preferably, for the colorant, use is made substantially or entirely of colorants applicable in liquid form, such as paint or ink. It is not excluded to work with staining agents. Liquid colorants have the advantage that they can penetrate more simply in the, possibly already partially densified, material mass. Of course, it is not excluded that for the colorant, at least partially pigments may be used consisting of solid matter. It is also possible to work with colored materials, which are added to the material mass. For example, in the case that the material mass contains wood particles and binding agents, one may also work with a portion of colored wood particles and/or colored binding agents.

When the colorant is applied on an already at least partially densified material mass, the addition thereof may be performed more smoothly. Moreover, the somewhat densified mass allows forming patterns and/or motifs more simply, and a good color rendition at the surface can be obtained.

Applying the colorant on or in the material mass can be performed according to various possible techniques. Below, two important possibilities are discussed, which possibly may be combined.

According to a first possibility, at least a portion of said colorant is provided on the surface of at least one flat side of the material mass, wherein this colorant, from this flat side, penetrates into said material mass up to a certain depth. As the material mass is not yet completely tight, a relatively deep coloration can be achieved. To this aim, for example, a jetting, spraying or atomizing device can be applied. For example, a device can be applied of the type known as such in other technological fields, such as the device from JP 6-155729. Such type of application device comprises one or more separately controllable application heads, such as spraying heads, which allow forming a motif or pattern. According to another example, a printing technique, such as offset printing, gravure printing, screen printing or pad printing, can be used, wherein then one or more elements, such as printing plates or printing cylinders, can be applied. It is clear that this example also allows forming motifs or patterns.

According to a second possibility, at least a portion of said colorant is provided internally in the material mass. To this aim, for example, one or more injection needles may be used, which are brought into the material mass and apply colorant internally. From the point of injection, the colorant, in view of the limited density of the material mass, can penetrate further into this material mass in all directions. Possibly, the injection needles may inject while moving, for example, moving up and down, such that a larger portion of the material mass is colored. Possibly, one or more of such injection needles may be separately controllable, such that also motifs or patterns can be formed by means of such application device. It is clear that the same device can be applied for providing colorant internally in the material mass as well as providing colorant on the surface of the material mass.

According to both herein above-mentioned possibilities, a relatively thick colored layer can be obtained at the surface of the final pressed material mass.

It is evident that according to the invention, only one as well as a plurality of colorants can be used, such that multi-colored colorations, whether or not with a pattern or a motif, can be obtained.

In the case that only one colorant is used, either a uniform, whether or not local, coloration can be obtained, or a coloration with a range of coloring in that the colorant is applied otherwise than in a uniform manner, or in that a coloration is applied which is not completely covering, such that, for example, the actual color of the pressed material mass as such forms a basic color for the decor.

In the case that a plurality of colorants are used, as such similar colorations can be obtained as when working with only one colorant. Moreover, it is possible to form color patterns or motifs. Preferably, at least three colors are used, to which black possibly will be added. For these three colors, basic colors such as cyan, magenta and yellow, or red, green and blue can be chosen, from which then any tint can be composed.

Preferably, said material mass to be pressed substantially consists of wood particles which are provided with a binding agent. For example, use can be made of the material masses which are known for forming MDF, HDF or wood particle board.

When starting from these material masses known as such, for example, from a material mass which can be applied for forming an MDF or HDF board, then it is possible to apply, with a minimum of adaptations, the present method to a production line of MDF or HDF board, wherein then said colorant can be added at least partially after the material mass has been composed from the wood fibers provided with binding agent, and before or after the first densifying or deaerating step in the so-called pre-press has taken place, wherein after the deaerating step the actual press treatment is continued. An example of such method is characterized further in the detailed description. It is also noted that it is also important to obtain a certain depth of the coloration, when the colored board or panel still has to be grinded afterwards. A depth of several tenths of millimeters may suffice. Such grinding operation is common, however, not mandatory, when producing MDF or HDF boards.

It is clear that the method of the invention can be applied for manufacturing larger board materials, from which then, by subdividing, the actual substrates of one or more panels are obtained. Such subdividing preferably is performed after the board material has attained its final density.

According to a second aspect, the present invention also relates to panels which can be obtained by means of a method having the characteristics of the first aspect. According to preferred embodiments of the invention, it also aims at a panel which can offer a solution for one or more disadvantages of the state of the art. To this aim, the invention, according to its second independent aspect, relates to a panel comprising a substrate, wherein this substrate substantially consists of a pressed material mass, with the characteristic that said pressed material mass, at least at one flat side of the substrate, shows a coloration extending from the respective side in the substrate up to a maximum depth situated between 0.5 millimeters and half of the thickness of the respective panel.

It is clear that according to the second aspect of the invention, a rather local coloration next to the decorative side of the panel is desired and that the substrate does not show this coloration over its entire depth. The coloration preferably is limited to a layer-shaped zone of the substrate, which is situated next to or at the surface of the side concerned. However, this layer-shaped zone has a minimum thickness of 0.5 millimeters, such that it is somewhat resistant against traces of wear. It is clear that the respective coloration relates at least to a coloration of the substrate material itself, contrary to possible layer-shaped colorations, such as prints or layers of paint, which are solely provided on the surface. It is clear that by performing the coloration locally, already an economization of color pigment may be realized. Moreover, such limited coloration allows more cost-effective production procedures, which moreover can lead to new possibilities. For example, the method of the first aspect may be applied.

It is clear that the colorations of the invention form at least a portion of the finally visible surface or the decorative side of the panel. This visible surface may be situated at the edges of the panels, for example, on the surface of a chamfer, as well as on the actual upper surface of the panels.

Preferably, the local coloration extends at least over the entire actual upper surface of the panels. By the “actual” upper surface, the upper surface of the panels is meant, with the exception of possible deepened edges, such as deepened edges having the form of chamfers, bevels, joints, grooves or gaps. According to the invention, it is, of course, also possible that the local coloration is situated substantially in one or more of such deepened edges.

Preferably, said local coloration extends at the most from said flat side up to a depth corresponding to half, and still better at the most up to a fourth of the thickness of the panel. It is noted that the typical thicknesses of the substrates, which can be applied with the panels of the invention, may be between 5 and 25 millimeters. The closer the coloration concerned is situated at the surface of the panel, the better the color rendition can be realized at this surface and/or the more cost-effective the panel may be manufactured. The deeper the coloration concerned extends, the deeper wear traces may be before the coloration disappears and the panel becomes esthetically unattractive.

It is noted that the panel of the invention can have such a deep coloration that the surface of the panel can be re-sanded several times. This can be of advantage when such panels are applied as floor panels, as then possibly maintenance schemes as those common for parquetry can be applied.

Preferably, said local coloration extends at the most from said flat side up to a depth of maximum 4 millimeters, and still better of maximum 2 millimeters. With these values, a good coloration is obtained independently from the thickness of the substrate. On the one hand, the colored zone best should not be too shallow, as a bad color rendition may be obtained due to the proximity of underlying non-colored zones; on the other hand, it is unnecessary to perform the colored zone too deep, as wear traces seldom will continue up to more than 4 millimeters underneath the surface. Preferably, a minimal depth of the local coloration of 0.5 millimeters is applied. The preferred maximum of 4 millimeters allows one or two sanding operations. This corresponds, for example, to the possibilities offered with so-called “engineered wood” parquetry, which comprises a hard wooden top layer of approximately 4 millimeters, provided on a core material.

According to a preferred embodiment, the panel of the invention, at the flat side concerned, is provided with a transparent or translucent layer on the basis of synthetic material. By means of such a layer, a wear-resistant covering can be obtained above the decor-forming coloration. The synthetic material concerned may comprise lacquer, resin, melt glue, or a, preferably layer-shaped, combination thereof. As a lacquer, radiation-hardening lacquers, such as UV-hardening or electron beam-hardening lacquers can be applied. As a resin, thermo-hardening or thermoplastic resins can be applied, such as melamine or other amino resins. Preferably, the synthetic material also comprises hard particles, such as mineral or ceramic particles, which impart wear-resistant and/or scratch-resistant features to such synthetic material layer. For example, aluminum oxide or silicon oxide particles can be applied. Preferably, particles are used which have an average particle size situated between 0.2 and 200 μm. The synthetic material layer may or may not comprise a material sheet, such as a transparent paper sheet. Such paper sheet allows applying the respective synthetic material at least partially by means of this material sheet. According to another possibility for obtaining a certain wear resistance or scratch resistance, it is also possible that said hard particles are integrated in said coloration of the pressed material mass itself.

As such, the combination of a translucent or transparent synthetic material layer and a coloration forming a decor has particular advantages, whether or not this relates to a coloration which is restricted in depth. Therefore, the invention, according to a third independent aspect, also relates to a panel comprising a substrate, wherein this substrate substantially consists of a pressed material mass, having the characteristic that said pressed material mass, at least at one flat side of the substrate, shows a coloration, whereas at the respective flat side a translucent or transparent layer on the basis of synthetic material is applied, as a result of which said coloration is at least partially visible and wherein the panel, at the respective flat side, is provided with a structure of impressions and/or projections.

Providing a synthetic material layer allows forming a wear-resistant and/or scratch-resistant layer above the decor-forming coloration, according to the possibilities mentioned herein above.

The panel of the third aspect of the invention is provided with a structure of impressions and/or projections at its respective flat side. Preferably, this structure of impressions and/or projections is formed at least and still better exclusively in said synthetic material layer. However, it is not excluded that, whether or not in combination with a structured synthetic material layer, the respective side of the substrate as such is structured. It can be structured, for example, prior to providing the synthetic material layer. Preferably, this side of the substrate, however, is made substantially flat. Such flat side leads to a smoother application of said synthetic material layer, or, in the case that no such synthetic material layer is applied, it leads to a less pronounced wear. When forming a structure in said synthetic material layer, the techniques known as such for laminate panels may be applied, wherein by means of a heated structured press element impressions are formed in the synthetic material layer. It is not excluded that the impressions formed in this manner also continue into the substrate. For the state of the art in connection with forming impressions in the synthetic material layer of laminate panels, reference is made to WO 01/96689 and WO 2006/066776. It is clear that these techniques can be applied more smoothly than techniques wherein closed molds are used.

According to all aspects of the invention, the coloration may be uniform as well as show different colors or tints. It is possible to work with colorations showing a motif or pattern. Preferably, the pattern shows a coloration which forms a wood motif and/or represents a wood tint. However, it is not excluded that the coloration rather should show a stone motif and/or stone tint, or any other motif, such as a fashion motif.

According to preferred embodiments of the invention according to all of its aspects, said pressed material mass consists in particular of wood particles, which are interconnected by a binding agent, such as a polycondensation glue. For example, said pressed material mass may concern an MDF or HDF board, or a wood chip board. Preferably, the substrate shows a final density of more than 500 kg/m³ and still better a density of more than 700 kg/m³. Preferably, the substrate relates to a substrate made in one piece, which consists of only one layer of said pressed material mass, for example, only one layer of MDF or HDF, of which, according to the invention, at least a portion is colored.

Preferably, the panel of the invention, according to all its aspects, relates to a floor panel. Such floor panel preferably is made square or rectangular and can be provided, at least at two opposite edges, with coupling means allowing to couple two of such floor panels to each other. Preferably, this relates to coupling means by which at the respective edges a locking among two of such floor panels can be obtained, in a vertical direction perpendicular to the plane of the coupled floor panels as well as in a horizontal direction perpendicular to the respective edge and in the plane of the coupled floor panels. Of course, it is not excluded that such colorations might be applied in wall panels, ceiling panels or furniture panels. Possibly, they may also be applied in profiles which can be applied in combination with such panels, such as in skirting boards and other finishing profiles, wherein these profiles then, of course, do not necessarily have to be panel-shaped. For example, such colorations may be applied instead of the layer-shaped coatings in the finishing profiles known from WO 2006/074824.

It is clear that the method of the first aspect preferably can be applied for manufacturing panels showing the characteristics of the second and/or the third aspect.

Of course, panels having the characteristics of the second and/or the third aspect can be manufactured in other manners, too, wherein these methods also form independent inventive aspects of the invention. For example, it may be started from a material mass to be pressed, which is composed in a layered manner, wherein at least one of these layers comprises colorant before a first densifying operation is applied. According to another example, a completely pressed material mass, i.e. after having performed the last densifying operation, can be provided with the coloration.

Apart from said coloration, the panels of the invention also may comprise other decor portions. For example, it is possible to use the coloration of such panel as a background color for decor portions formed by a print, which, for example, is performed directly or indirectly on the colored side of this panel by means of techniques known as such for printing on wood-based boards. For such print, printing techniques may be applied such as offset printing, gravure printing, transfer printing, digital printing by means of inkjet printers and the like. For example, it is possible to apply a motif of wood pores and/or wood nerves on a basic board provided with a light brown or dark brown coloration, by means of a separate printing technique with the intention of obtaining a wood imitation. For examples of useful printing techniques, reference is made to the patent documents U.S. Pat. No. 1,971,067, U.S. Pat. No. 3,173,804, U.S. Pat. No. 3,554,827, U.S. Pat. No. 3,811,915, WO 01/48333, WO 01/47724, U.S. Pat. No. 2004/0026017, WO 2004/042168, EP 1 872 959 and DE 195 32 819 A1.

According to a particular embodiment of all aspects, a white or beige colorant is used as a colorant. The obtained panels, which have a white or beige-colored side, then can be directly printed by means of one or more of the also above-mentioned printing techniques, there, where according to the state of the art always one or more primer layers are necessary. According to another particular independent aspect, the present invention thus also relates to a panel-shaped or board-shaped semi-finished product for manufacturing printed panels, wherein this semi-finished product comprises a substrate, wherein said substrate substantially consists of a pressed material mass, having the characteristic that said pressed material mass, at least at one flat side of the substrate, comprises a coloration forming a basic layer for applying a print. It is clear that this relates to printed panels, of which the print concerned is formed on the panel, possibly by the intermediary of further basic layers, however, preferably without further basic layers. Further, it is clear that said coloration can be white or beige, or possibly may have another color, which preferably is adapted to the print to be formed thereon. Preferably, said coloration is made in a uniform manner. However, it is not excluded that the coloration already shows a certain pattern, for example, for forming so-called “plank effects”. By “plank effects”, limited tint differences are indicated, which appear preferably uniformly or approximately uniformly over one plank or floor part. Of course, it is possible that the panels having the characteristics of this particular independent aspect are manufactured by means of a method having the characteristics of the first aspect and/or the characteristics of the second and/or third aspect. The semi-finished product of this particular aspect preferably has its final density or at least approximately its final density. Preferably, the material mass of the semi-finished product corresponds or approximately corresponds to a material mass which can be applied for manufacturing MDF or HDF board material.

### BRIEF DESCRIPTION OF THE DRAWINGS

With the intention of better showing the characteristics of the invention, hereafter, as an example without any limitative character, some preferred embodiments are described, with reference to the accompanying drawings, wherein:

FIG. 1 schematically represents some steps in a method having the characteristics of the invention;

FIG. 2 represents a panel which can be obtained by means of such method;

FIG. 3 represents a cross-section according to the line III-III indicated in FIG. 2;

FIG. 4, at a larger scale, represents a view on the area indicated by F4 in FIG. 3;

FIG. 5, at a still larger scale, represents a view on the area indicated by F5 in FIG. 4; and

FIG. 6 represents another possible application of a panel which is manufactured by means of a method according to the invention.

### DESCRIPTION OF EXAMPLE, NON-LIMITING EMBODIMENTS OF THE INVENTION

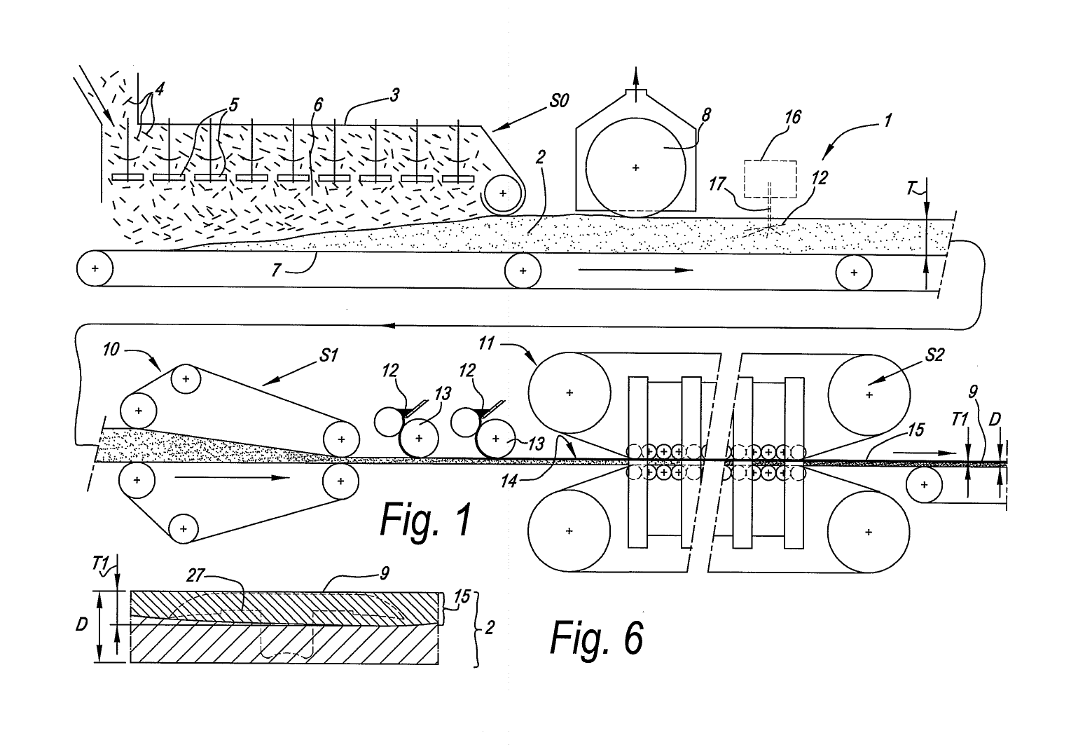

FIG. 1 schematically represents some steps S0-S1-S2 in a method having the characteristics of the first aspect of the invention. In the example, this relates to a method which is performed by means of a production line 1, which substantially corresponds to a typical MDF or HDF production line. Herein, it is started from a material mass 2, which, in a preceding step S0, has been composed at least by means of two components. In this case, both components together are supplied to a strewing machine 3, in the form of wood particles previously provided with binding agent, more particularly wood fibers 4 provided with polycondensation glue.

The strewing machine 3 of such production line 1 may be constructed in any manner. In the example, a strewing machine 3 is applied such as the one known from WO 03/053642. The strewing machine 3 of the example is provided with a plurality of agitating elements 5, which put the wood fibers 4, which are provided with glue, in motion in the strewing chamber 6. By means of the fibers 4 exiting the strewing chamber 6 at the bottom, the material mass 2 to be pressed is composed on the transport conveyor 7 situated there below. For a further description of such strewing machine 3, reference is made to the aforementioned international patent application. Of course, other types of strewing machines are also suitable, such as, for example, the strewing machines described in the international patent applications WO 99/36623 and WO 2005/044529.

Seen in flow direction, a so-called scalpel roller 8 is situated after the strewing machine 3, which roller removes possible excess wood fibers from the composed material mass 2, after which then a material mass 2 having a flat or virtually flat upper surface is obtained. It is noted that it is not mandatory to work with such scalpel roller 8.

The material mass obtained by strewing may have a thickness T which is up to 50 times or more larger than the thickness D of the finally to be obtained board material 9, as it is pressed, in one or more densifying steps S1-S2, until this required thickness D of the board 9 or the panel is achieved. During these densifying steps S1-S2, the material mass 2 experiences at least a doubling of its density. These further densifying steps S1-S2 are also represented schematically here.

In flow direction after said scalpel roller 8, there is a densifying device or pre-press 10, in which the material mass 2, prior to the actual hot pressing in step S2, gradually is densified to a condition in which it can be transported in a simpler manner compared to the un-densified material mass. To this aim, the material mass 2 during step S1 preferably, as represented here, is transported between pressing conveyors, wherein these pressing conveyors show an intermediate distance which decreases in flow direction. In this pre-densification in the pre-press 10, preferably no heat is supplied and/or, preferably, the present binding agent is not yet or only partially activated. Mainly, the pre-densification preferably aims at an at least partial removal of the gasses, such as air, present in the material mass 2.

After the densifying device or pre-press 10, seen in flow direction, the actual press device 11 is situated, in which the material mass 2, whether or not already pre-densified, is pressed under the influence of heat. The applied temperature may be situated, for example, between 100° C. and 150° C., and the applied pressure may be situated on average between 4 and 10 bar; however, short peak pressures up to 40 bar are not excluded herein. Preferably, the activation of the binding agent present substantially is performed in this press device 11. In the case of a polycondensation glue, water or rather steam may be created in this press device 11.

The press device 11 illustrated here is of the continuous type, namely, of the type in which the material mass 2 is transported and/or gradually pressed between pressing conveyors. In flow direction of such press device 11, a pressure and/or temperature course can be set. By means of this press device 11, the density of the already partially densified material mass 2 may at least be doubled. It is clear that the method of the invention can be performed by other press devices 11, too, such as, for example, by a steam pressure device, by a multi-level press or by a so called short-cycle press. In these other press devices, the applied pressure and/or temperature can be set in function of the time that the respective material mass 2 will remain in the press device.

The particularity of the method of the present invention is due to the fact that prior to one or more densifying steps S1-S2, a colorant 12 is added to the material mass 2. In the example of FIG. 1, this colorant 12 is added in between two press treatments S1 and S2, namely, after the densifying device or pre-press 10 and before the actual press device 11. To this aim, colorant 12 is provided on the already partially densified material mass 2 by means of one or more printing cylinders 13, in this case, two printing cylinders 13. For this purpose, for example, printing cylinders may be applied which are typical for offset printing or gravure printing. Such arrangement allows obtaining a motif or pattern.

Although in the example the colorant 12 is provided on the surface 14 of a flat side of the material mass 2, still a coloration 15 with a certain depth T1 is obtained in that the applied colorant 12 penetrates from the respective flat side up to a certain depth into the material mass 2.

The fact that two printing cylinders 13 are applied does not necessarily mean that a plurality of colors is used. Working with a plurality of printing cylinders 13, which apply colorant 12 of one and the same color, namely as such also has the advantage that a larger flow rate of applied colorant 12 can be achieved.

In dashed line 16, also an application device for colorant 12 is represented, which can be applied instead of the printing cylinders 13 or in combination with the printing cylinders 13 or in combination with other application devices. In this case, the application device 16 is situated before the densifying device or pre-press 10, however, preferably after the scalpel roller 8, if such scalpel roller 8 is present. Herein, this relates to an application device which can provide the colorant 12 internally in the material mass 2 by means of one or more injection needles 17, which possibly can move up and down. Of course, it is possible that this application device is provided on another location in the production line 1, for example, seen in flow direction, after the densifying device or pre-press 10 and preferably before the actual press device 11.

After the actual press device 11, then a panel or board 9 is obtained having two substantially flat board or panel sides, however, wherein the pressed material mass 2 of this panel or this board 9, at least at one flat side thereof, shows a coloration 15. In the example, this coloration 15 is such that it extends from the respective side up to a maximum depth T1 situated between 0.5 millimeters and half of the thickness D of the panel or the board 9. Therefore, it is clear that a panel or a board 9 is obtained, which shows the characteristics of the second aspect of the invention.

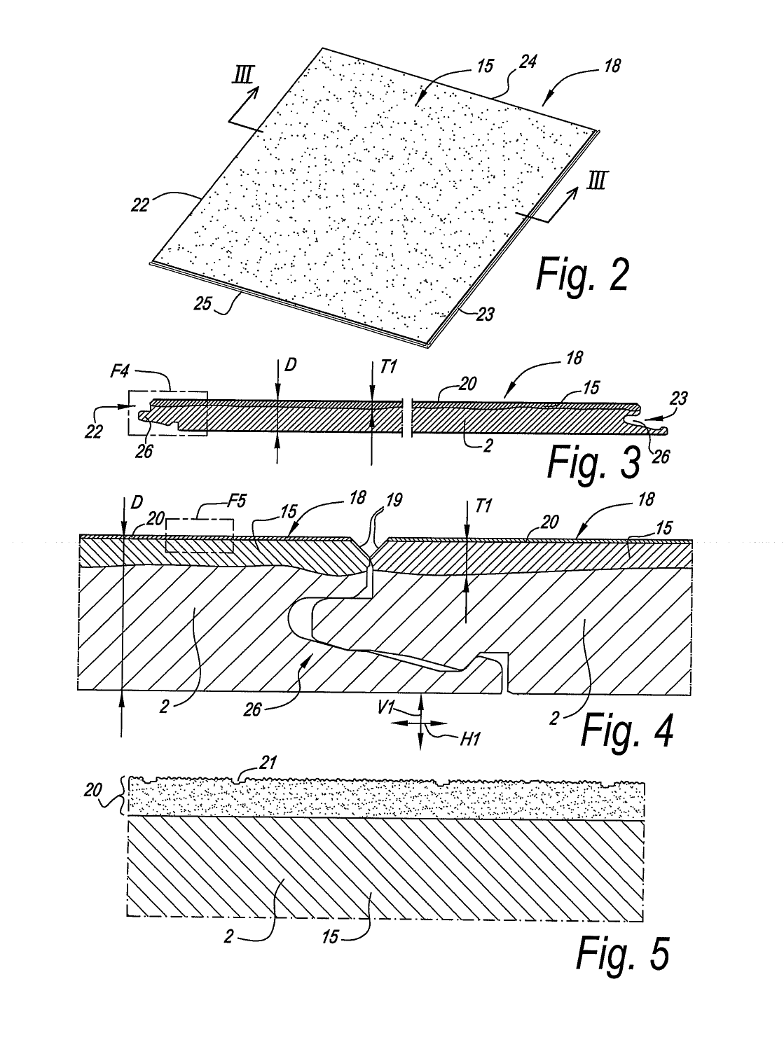

FIG. 2 shows a floor panel 18, which is manufactured by means of a method according to the first aspect of the invention and which also shows the characteristics of the second and the third aspect. Herein, this relates to a panel 18 forming a tile imitation. The decor of this tile imitation is substantially or even entirely formed by means of the coloration 15, provided according to the invention, of the pressed material mass 2. Herein, the pressed material mass (2) forms the substrate of the floor panel 18.

It is clear that panels or floor panels having the characteristics of the invention may have any shape, however, preferably are rectangular and oblong, or square. Further, it is clear that according to the invention also other imitations than tile imitations can be formed. For example, it is possible to manufacture panels with wood imitations or fashion motifs.

FIG. 3 represents that the pressed material mass 2 of the substrate of the floor panel 18 shows a layer-shaped coloration 15 at the upper side, said coloration extending from this side up to a maximum depth T1, which approximately corresponds to a fourth of the thickness D of the panel 18, or extends approximately 2 millimeters in depth.

FIG. 4 clearly shows that the coloration 15 is of such a depth that it is also present on the surface of the chamfers 19, more particularly bevels, which are present. In this case, the entire surface of the chamfers 19, which are present, is provided in the colored layer 15 of the pressed material mass 2. FIG. 4 also shows that the upper side of the panel 18 is provided with a transparent layer 20 on the basis of synthetic material, which possibly may comprise wear-resistant particles. Said coloration 15 remains visible through this synthetic material layer 20.

FIG. 5 represents that the panel 18, at the side where the coloration 15 is applied, is provided with a structure 21 of impressions and/or projections. In this case, this relates to a structure 21, which remains restricted in the synthetic material layer 20 and may be realized according to techniques therefor which are known as such. For example, the structure 21 can be formed mechanically by providing impressions in the synthetic material 20 by means of a structured press element. According to another example, the structure 21 can be formed chemically by applying an agent on or underneath the synthetic material, said agent affecting the hardening of this synthetic material.

In reference to FIGS. 2 and 4, it is also noted that the floor panel 18, at both pairs of opposite edges 22-23 and 24-25, is provided with coupling means 26, which allow that two of such floor panels 18 can be locked with each other in a horizontal direction H1 as well as in a vertical direction V1. Such coupling means 26 are known as such, for example, from WO 97/47834.

Further, it is noted that the panels 18 or boards 9 of the invention are particularly suited for removing material in the actual upper surface of the panels 18, for example, for forming an imitation gap or an imitation chamfer. Such imitation chamfer does not necessarily have to be provided with an additional decorative covering. When it is restricted in depth, the surface of the imitation chamfer may extend exclusively in the coloration 15. Such imitation chamfers are not represented here, however, may be applied, for example, in the case that the panel of the invention as such is intended for imitating a plurality of panels or tiles, for accentuating the transition between these panels or tiles.

FIG. 6 also shows that the panels or boards 9 of the invention also can be applied in particular applications, wherein the end product is not necessarily board-shaped. For example, as represented by the dashed line 27, a finishing profile for a floor covering can be obtained, which has a coloration 15 at its upper surface. To this aim, the board 9 or the panel of the invention can be processed in a manner known as such, for example, by means of milling operations or other machining treatments.

According to a not-represented example, it is also possible to manufacture profiled furniture panels with the panels or boards 9 of the invention, wherein the coloration 15 then preferably also remains present in the deepest-profiled areas of the surface.

The present invention is in no way limited to the embodiments described herein above; on the contrary, such panels and methods may be realized according to various variants, without leaving the scope of the present invention.

1. A method for manufacturing panels including a substrate on the basis of a pressed material mass, the method comprising:
performing one or more densifying steps on a material mass to at least double the density of the material mass; and
prior to one or more of the densifying steps, adding a colorant is added to the material mass.

2. The method of claim 1, characterized in wherein at least a portion of the colorant is provided on the surface of at least one flat side of the material mass; and
wherein the colorant, from the flat side, penetrates into the material mass.

3. The method of claim 1, wherein at least a portion of the colorant is delivered internally into the material mass.

4. The method of claim 1, wherein prior to one or more of the densifying steps, the material mass to be pressed substantially consists of wood particles, which are provided with a binding agent.

5. (canceled)

6. The method of claim 1, wherein the density of the material mass, is at least doubled after adding the colorant.

7. The method of claim 1, wherein the colorant is at least partially added in between two of the densifying steps.

8. A panel comprising:
a substrate, including a pressed material mass;
wherein the pressed material mass, at least at one flat side of the substrate, shows a coloration extending from the flat side into the substrate to a maximum depth situated between 0.5 millimeters and half of the thickness of the respective panel.

9. The panel of claim 8, wherein the coloration extends at the most from the flat side to a depth corresponding to a fourth of the thickness of the panel.

10. The panel of claim 8, wherein the coloration extends at the most from the flat side to a depth of 4 millimeters.

11. The panel of claim 8, comprising a transparent or translucent layer on the basis of a synthetic material, which is provided on the flat side of the substrate.

12. The panel of claim 8, comprising a structure of impressions and projections provided on the flat side of the substrate.

13. A panel comprising:
a substrate including a pressed material mass;
wherein the pressed material mass, at least at one flat side of the substrate, shows a coloration;
wherein a translucent or transparent layer on the basis of synthetic material is provided on the flat side of the substrate, as a result of which the coloration is at least partially visible; and
wherein a structure of impressions and projections is provided on the flat side of the substrate.

14.-18. (canceled)
